(19) United States
(12) Patent Application Publication
(10) Pub. No.: US 2008/0257674 A1
(43) Pub. Date: Oct. 23, 2008

(54) Hydrodynamic clutch arrangement

(75) Inventors: Christoph Sasse, Schweinfurt (DE); Bernd Reinhardt, Schonungen/Forst (DE); Gregor Sueck, Sennfeld (DE); Oliver So, Schweinfurt (DE); Monika Rossner, Donnersdorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/148,191

(22) Filed: Apr. 17, 2008

(30) Foreign Application Priority Data
Apr. 18, 2007 (DE) 10 2007 018 272.6

(51) Int. Cl. F16D 33/00

(52) U.S. Cl. 192/3.29

(57) ABSTRACT

A hydrodynamic clutch arrangement includes a clutch housing in which at least one hydrodynamic circuit formed by at least one pump wheel and one turbine wheel is provided. A bridging clutch can be actuated to produce an engaging movement to establish a working connection between a drive and a takeoff and to produce a disengaging movement to release this working connection. The hydrodynamic circuit and at least one pressure space are each connected by a flow route to pressure medium reservoir for actuating the clutch. At least one flow route serving to the fill the clutch housing is provided with a device for reducing the flow volume, which opens during the operating state to unblock the flow route but closes during the non-operating state to delay, at least, the drop in the internal pressure inside the clutch housing and thus in its filling volume.

### BACKGROUND OF THE INVENTION

1. Field of the Invention

The invention pertains to a hydrodynamic clutch arrangement including a clutch housing which can rotate about an axis of rotation, a hydrodynamic circuit formed by a pump wheel and a turbine wheel in the clutch housing, and a bridging clutch which can be actuated to establish and release a working connection between a drive and a takeoff.

2. Description of the Related Art

A hydrodynamic clutch arrangement of this type, as known from U.S. Pat. No. 7,143,879, is used to make or break a working connection between a drive, such as the crankshaft of an internal combustion engine, and a takeoff, such as a gearbox input shaft, and is provided with a clutch housing, which rotates around an axis of rotation. In U.S. Pat. No. 7,143,879, the clutch arrangement is designed as a hydrodynamic torque converter, in which a hydrodynamic circuit is provided with a pump wheel, a turbine wheel, and a stator. In addition, the hydrodynamic clutch arrangement is provided with a bridging clutch, by means of which the hydrodynamic circuit can be bypassed for the transmission of torque from the drive to the takeoff, where a torsional vibration damper with two sets of damping springs to damp torsional vibrations is assigned to the bridging clutch.

The hydrodynamic torque converter described in U.S. Pat. No. 7,143,879 illustrates a development tendency frequently applied in recent years to hydrodynamic clutch arrangements, according to which a torus space enclosed by a pump wheel, a turbine wheel, and a stator has only limited dimensions, so that the clutch arrangement will have a more compact design. At the same time, a large bridging clutch is required to transmit high torques, and thus a highly effective and therefore complex torsional vibration damper is also required. These two components occupy large amount of space in the clutch arrangement.

During the prolonged periods when a motor vehicle with a hydrodynamic clutch arrangement is idle, a considerable portion of the fluid present in the clutch housing leaves the clutch housing and flows into the associated gearbox. When the vehicle is started up again, the fluid remaining in the clutch housing is first distributed within the clutch housing by centrifugal force. Only a portion of this fluid thus arrives in the torus space, where it is available for the transmission of torque. This problem is made even worse when the transmission is shifted into “Drive”(D), because as a result, the drive goes into action at a predetermined rotational speed, whereas the takeoff and thus the torsional vibration damper remain at least essentially at rest. In spite of the centrifugal force being generated, fluid is thus drawn off through the torsional vibration damper in the radially inward direction, which, in principle, should be compensated by fluid being drawn from the torus space. It is true that, in cases where the hydrodynamic clutch arrangement is designed as a two-line system, fresh fluid is introduced during this operating state into the clutch housing from a fluid reservoir via the opened bridging clutch. However, this fluid does not reach the torus space either but instead is also suctioned off radially toward the inside. When the vehicle is being driven off, these conditions are expressed by the almost complete inability of the torus space, which is more-or-less empty, and the bridging clutch, which is open, to transmit the torque being introduced from the drive to the takeoff. Only the slippage torque present in the bridging clutch is able to ensure the transmission of a certain residual amount of torque. Only as the clutch continues to fill up at a slowly increasing rate does fresh fluid begin to enter and to fill the torus circuit. This type of performance characteristic cannot be tolerated in a modern motor vehicle.

### SUMMARY OF THE INVENTION

The invention is based on the task of designing a hydrodynamic clutch arrangement in such a way that, when the motor vehicle is to be started up, it can be ensured, even after the passage of a certain minimum idle time, that there will be a sufficient amount of fluid in the clutch space and that therefore it will be possible for a satisfactory amount of torque to be transmitted.

According to the invention, at least one of the flow routes serving to fill the clutch housing is provided with a blocking means, which opens to unblock the flow route during the operating state of the hydrodynamic clutch device but closes in the non-operating state to delay, at least, the drop in the internal pressure in the clutch housing and thus in its filling volume. This guarantees that fresh fluid, referred to in the following as flow medium, will always be able to enter the clutch housing and especially the hydrodynamic circuit during the operating state of a motor vehicle in which a hydrodynamic clutch arrangement is installed, whereas only a negligibly small amount of the flow medium contained in the clutch housing will be able to escape from the clutch housing and to enter the associated gearbox at the beginning of a period in which the motor vehicle and thus its hydrodynamic clutch device are idle.

Thus, even after long periods of idleness of the motor vehicle, at least most of the flow medium present in the clutch housing when the motor vehicle is turned off will be available for the transmission of torque upon resumption of vehicle operation. It is thus ensured that the hydrodynamic clutch arrangement will be available for use as intended at all times. This action of the blocking means can be explained as follows:

It is especially advantageous for the blocking means to be located between a supply line of a flow route and a space in the clutch housing such as the hydrodynamic circuit. During the operating state of the hydrodynamic clutch arrangement, the pressure in the supply line of the flow route is usually considerably higher than that in the hydrodynamic circuit, which means that the blocking means, which forms a separating point within the flow route, is kept open by the pressure in the supply line, which is positive versus the pressure in the hydrodynamic circuit. The blocking means is preferably pretensioned in the direction toward the supply line, so the blocking means will not open until after a predetermined pressure and force relationship has occurred, namely, one which exceeds the pretension. The pressure relationship is produced here between the supply line of the flow route and the hydrodynamic circuit, and the force relationship is produced by the action of the centrifugal force present during the operating state. As soon as the operating state of the hydrodynamic clutch arrangement is ended by turning off the motor vehicle in which it is installed, the positive pressure in the supply line of the flow route versus the hydrodynamic circuit and also the action of centrifugal force also come to an end, whereupon the blocking means closes as a result of its pretensioning toward the supply line. As a result, the hydrodynamic circuit becomes essentially pressure-tight in its supply area, which means that the escape of flow medium still present in the hydrodynamic circuit causes a loss of pressure in the outflow area of the hydrodynamic circuit. This pressure loss prevents at least most of the rest of the flow medium from leaving the hydrodynamic circuit via its outflow area, so that ultimately, after it has closed, the blocking means, without blocking off the outflow area, ensures that at least a significant portion of the flow medium remaining in the clutch housing in the non-operating state is kept inside the clutch housing.

So that the blocking means can take advantage of the previously mentioned positive effect of centrifugal force, it is located and designed in such a way that the centrifugal force supports the opening of the blocking means in the operating state, whereas, in the non-operating state, no centrifugal force is acting, and thus there is no impediment to the reliable closing of the blocking means.

Without the inventive blocking means, air would be drawn in via the inflow area, which is essentially pressureless in the non-operating state, when the pressure in the clutch housing, i.e., in particular in the hydrodynamic area, is lost as a result of the escape of flow medium via the outflow area. The indrawn air could intrude into certain individual areas of the clutch housing and thus form air inclusions, which would limit the uptake of flow medium into the clutch housing and thus its degree of filling and simultaneously promote the escape of flow medium out of the clutch housing. Because the blocking means is held in the closed position in the non-operating state, no air can be drawn in via the inflow area, and thus any limitation on the degree to which the clutch housing can be filled with medium is effectively prevented.

In an advantageous embodiment, the blocking means is mounted on a hub, which is provided inside the clutch housing. Flow passages of at least one flow route pass through this hub. Preferably this is a hub on which the turbine wheel and/or a torsional vibration damper is mounted, and which therefore is to be referred to here in brief as the “carrier hub”. In an advantageous design, the blocking means is designed either as a elastomeric seal, which surrounds the flow passages at least essentially in a ring-like manner or as a valve element located in each of the flow passages.

The blocking means is designed with a blocking element, which works together with a sealing seat. The blocking element can extend at least essentially in a ring-like manner around the carrier hub in the area where the flow passages are located, preferably with pretension toward the flow passages, so that the blocking element remains on its sealing seat until a pressure and force relationship corresponding to the pretension is reached. This pressure and force relationship will not be present while the hydrodynamic clutch device is in the non-operating state and the supply line of the flow route is therefore at least essentially pressureless. Upon the transition to the operating state, however, the pressure present in the supply line of the flow route will exceed the pretension of the blocking element and thus lift the latter from its sealing seat. As a result, the flow passages of the flow route are unblocked, and flow medium present in the supply line can pass through the area of the blocking element and arrive in, for example, the hydrodynamic circuit.

When the blocking means is designed as a valve device inside a flow passage of the flow route, the valve device remains in the closed position until the previously explained predetermined pressure and force relationship is reached; that is, it remains in the closed position in the non-operating state, because the pretension acting on the valve element, preferably produced by a valve spring, keeps the element seated with a sealing action on its seat. When this pressure and force relationship is exceeded in the operating state, however, the valve element is lifted from the sealing seat against the pretensioning force of the valve spring and thus the flow passages are unblocked. It is especially preferable for the valve device to consist of a throttle-type check valve.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows the upper half of a longitudinal cross section through a clutch housing of a hydrodynamic clutch device with a plurality of flow routes for fluid medium;

FIG. 2 shows an enlarged view of the area in the circle designated “Y” in FIG. 1 to illustrate a flow route with a blocking means for blocking the flow route, this blocking means being in the form of a seal on a hub, which serves to hold a torsional vibration damper and the turbine wheel; and

FIG. 3 is the same as FIG. 2 except that it shows a blocking means in the form of a valve device.

### DETAILED DESCRIPTION OF THE PRESENTLY PREFERRED EMBODIMENTS

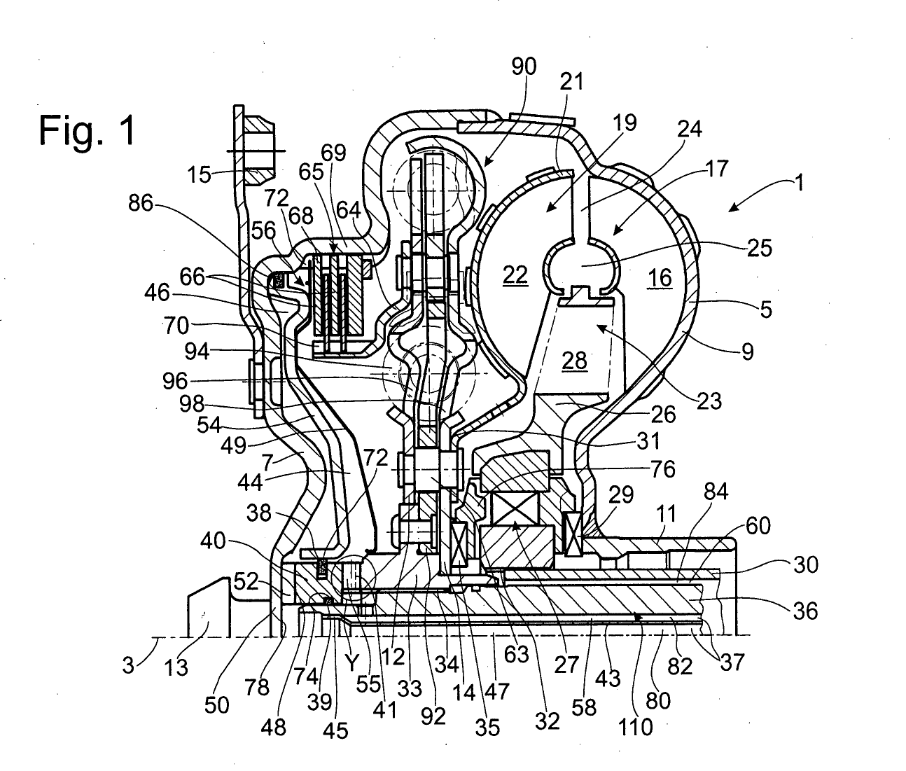

FIG. 1 shows a hydrodynamic clutch device 1, designed as a hydrodynamic torque converter. The hydrodynamic clutch device 1 has a clutch housing 5, which is able to rotate around an axis of rotation 3. On the side facing a drive (not shown), such as the crankshaft of an internal combustion engine, the clutch housing 5 has a drive-side housing wall 7, which is permanently connected to a pump wheel shell 9. This merges in the radially inner area with a pump wheel hub 11.

To return to the drive-side housing wall 7: On the side facing the drive (not shown), this wall has a bearing journal 13, which, in a manner which is already known and therefore not illustrated in detail, is provided to engage an element of the drive, such as the crankshaft, for the drive-side mounting of the clutch housing 5. In addition, the drive-side housing wall 7 has fastening mounts 15, which serve in the conventional manner to allow the clutch housing 5 to be fastened to the drive, preferably by way of a flexplate (not shown). With respect to drawings which show the mounting of the bearing journal of a hydrodynamic clutch element in a crankshaft of a drive and the connection of the hydrodynamic clutch device by way of a flexplate to the crankshaft, reference can be made by way of example to FIG. 1 of U.S. Pat. No. 4,523,916.

The previously mentioned pump wheel shell 9 cooperates with pump wheel vanes 16 to form a pump wheel 17, which works together with, first, a turbine wheel 19 consisting of a turbine wheel shell 21 and turbine wheel vanes 22, and, second, with a stator 23. The pump wheel 17, the turbine wheel 19, and the stator 23 form a hydrodynamic circuit 24 in the known manner, which encloses an internal torus 25.

It should also be mentioned that the stator vanes 28 of the stator 23 are mounted on a stator hub 26, which is itself mounted on a freewheel 27. The latter is supported axially by an axial bearing 29 against the pump wheel hub 11 and is connected nonrotatably but with freedom of relative axial movement by way of a set of teeth 32 to a support shaft 30, which is located radially inside the pump wheel hub 11. The support shaft 30, which is itself designed as a hollow shaft, radially encloses a gearbox input shaft 36, serving as the takeoff 110 of the hydrodynamic clutch device 1, this input shaft being provided with a central bore 37. This central bore 37 holds a sleeve 43 in such a way that the sleeve 43 is centered radially in the central bore 37 by support areas 45. With an axial offset from these support areas 45, the sleeve 43 forms a first supply channel 58 for fluid medium, referred to in the following as flow medium, radially between itself and the enclosing wall of the center bore 37. In the present design of the hydrodynamic clutch arrangement 1, this supply channel acts as a supply line for the flow medium. Radially inside the sleeve 43 there remains a channel, i.e., the central supply channel 47.

The gearbox input shaft 36 has a set of teeth 34 by which it holds a hub 33 so that it cannot rotate but is free to move in the axial direction. A takeoff-side hub disk 92 of the torsional vibration damper 90 is attached to the radially outer area of the hub 33. The hub disk 92 has a set of circumferential springs 94 by which it cooperates with two cover plates 96, 98, as components 12, 14 in the clutch housing 5, where the cover plates 96, 98 are also parts of the torsional vibration damper 90. The cover plate 98 as component 14 serves to accept a turbine wheel base 31 by means of a riveted connection 63, whereas the other cover plate 96 is designed so that an inner plate carrier 64 of a clutch device 65, which is designed as a multi-plate clutch, can be attached to it. The clutch device 65 has both inner clutch elements 66, which are connected nonrotatably to the inner plate carrier 64 by a set of teeth 70 on the carrier, and outer clutch elements 68, which can be brought into working connection with the inner clutch elements 66, where the outer clutch elements 68 are connected for rotation in common to the drive-side wall 7 and thus to the clutch housing 5 by means of a set of teeth 72, acting as an outer plate carrier 69. The clutch device 65 can be engaged and disengaged by means of an axially movable piston 54 and cooperates with the piston 54 to form a bridging clutch 56 of the hydrodynamic clutch device 1. As FIG. 1 shows, a separating plate 49 can be provided between the piston 54 and the torsional vibration damper 90 to isolate the hydrodynamic circuit 24 from a supply space 44, bounded axially by the piston 54 and the separating plate 49. On the side of the piston 54 facing away from this supply space 44, a pressure space 46 is provided, bounded axially by the piston and by the drive-side housing wall 7. The piston 54 is centered in the clutch housing 5 by a seal 86, which holds the piston in place and seals it off against the housing.

The hub 33 is called the “carrier hub” 33 in the following, because it holds not only the torsional vibration damper 90 but also, indirectly, i.e., by way of the vibration damper, the turbine wheel 19. On one side, this hub is supported against the freewheel 27 by way of the cover plate 98 and a bearing 35, which is designed as an axial bearing, and then by way of a thrust washer 76, whereas, on the other side, i.e., at the end facing the drive-side wall 7, which forms an axial bearing area 48, it can be supported axially against an axial contact surface 50 of the drive-side housing wall 7, where this axial contact surface 50 extends radially outward from the axis of rotation 3 of the clutch housing 5. The bearing journal 13 is attached to the opposite side of the drive-side housing wall 7 of the clutch housing 5, inside the area over which this axial contact surface 50 extends.

Radially on the inside, the carrier hub 33 is sealed off against the gearbox input shaft 36 by a seal 39, which is held in a seal recess 74; radially on the outside, it is sealed off against the piston 54 of the bridging clutch 56 by a seal 38, held in a seal recess 72. These two seals 38, 39 separate passages 52, which pass through the carrier hub 33 in its axial bearing area 48 and are preferably designed with groovings 85 in the axial bearing area 48, from other flow passages 55, which are formed in the axial part of the carrier hub 33 between the piston 54 and the torsional vibration damper 90. The flow passages 52 are in flow connection with the central supply channel 47 of the sleeve 43, which acts as a central flow route 80, whereas the other flow passages 55 are in flow connection with the first supply channel 58 located radially between the sleeve 43 and the wall of the central bore 37 in the gearbox input shaft 36 surrounding the sleeve, where this supply channel 58 acts as the first flow route 82. In addition, a second supply channel 60 is provided radially between the gearbox input shaft 36 and the support shaft 30, where this channel acts in the present embodiment of the hydrodynamic clutch arrangement 1 as a discharge line for the flow medium and serves as a second flow route 84.

By way of the flow passages 52, the central flow route 80 serves to establish a positive pressure in the pressure space 46 versus the supply space 44 and thus to actuate the piston 54 of the bridging clutch 56, causing it to engage, i.e., to move toward the clutch device 65, as a result of which a frictional connection is produced between the individual clutch elements 66, 68. To generate this positive pressure in the pressure space 46 versus the supply space 44, there must be connection between the central flow route 80 and a control device and a hydraulic fluid reservoir. Neither the control device nor the hydraulic fluid reservoir is shown in the drawing, but they can be found in FIG. 1 of U.S. Pat. No. 5,575,363, which is hereby incorporated by reference in present patent application.

By way of the set of teeth 34 and the flow passages 55, the first flow route 82 serves to produce a positive pressure in the supply space 44 versus the pressure space 46 and thus to actuate the piston of the bridging clutch 56, causing it to disengage, i.e., to move away from the clutch device 65, as a result of which the frictional connection between the individual clutch elements 66, 68 of the clutch device 65 is released. To generate this positive pressure in the supply space 44 versus the pressure space 46, there must be a connection between the first flow route 82 and the previously mentioned control device and the previously mentioned hydraulic fluid reservoir.

Fluid medium which has arrived in the supply space 44 via the first flow route 82 and the flow passages 55 cools the clutch elements 66, 68 of the clutch device 75 and then enters the hydrodynamic circuit 24, from which it emerges again via the second flow route 84.

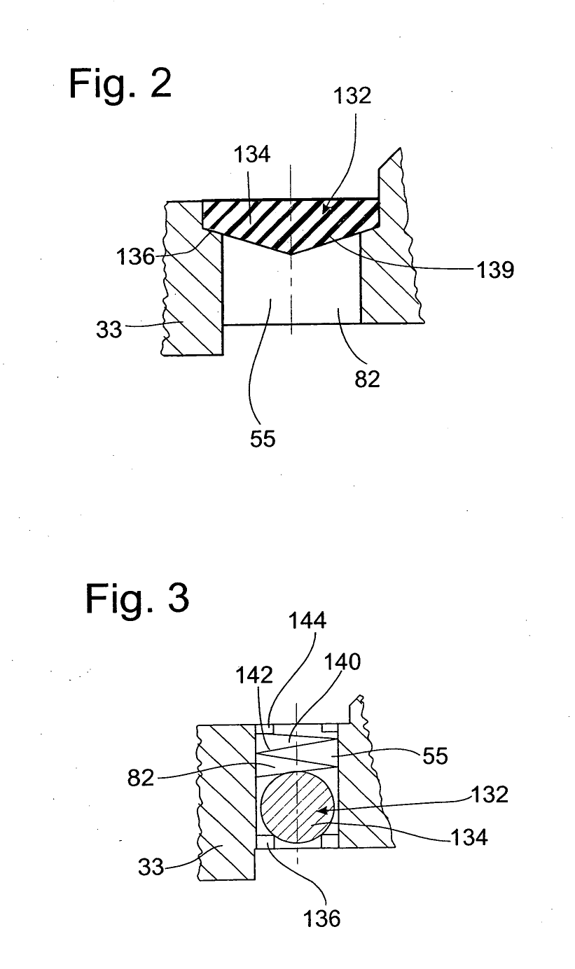

The area of the carrier hub 33 inside the circle marked “Y” in FIG. 1 is shown on an enlarged scale in FIGS. 2 and 3. FIG. 2 shows an at least essentially ring-shaped blocking element 134 in the form of an elastomeric seal 139, which surrounds the carrier hub radially and which is held on a sealing seat 136 by the action of internal pretension. The sealing seat 136 surrounds a flow passage 55 of the first flow route 82 and is provided on the radial side of the carrier element 33 facing the elastomeric seal 139. The internal pretension is achieved by radial expansion of the blocking element 134, that is, of the elastomeric seal 139, this being done when the seal is initially mounted on the carrier hub 33. In the operating state, a positive pressure is present in the first supply channel 58 versus the pressure in the supply space 44, and, as a result of this pressure and force relationship, the blocking element 134 is caused to expand even more against the action of its own internal pretension. When this expansion occurs, the blocking element 134 moves away from the sealing seat 136 and thus unblocks the flow passages 55 so that the supply space 44 can be supplied with fresh flow medium.

As soon as the motor vehicle in which the hydrodynamic clutch arrangement 1 is installed is turned off and thus the clutch arrangement is switched over into the non-operating state, there is no longer a positive pressure in the first supply channel 58 versus the supply space 44, so that the blocking element 134, under the action of its pretension, can return to its original position, that is, back onto the sealing seat 136. Thus the flow passages 55 are closed in an essentially pressure-tight manner. Because the supply space 44 is in pressure and flow connection with the hydrodynamic circuit 24, a negative pressure is generated in the hydrodynamic circuit 24 when flow medium leaks out of the hydrodynamic circuit 24 via, for example, the second flow route 84, and this negative pressure at least decreases any further escape of flow medium through the second flow route 84. The blocking element 134 also prevents the negative pressure building up in the hydrodynamic circuit 24 from drawing air out of the first flow route 82 through the flow passages 55. When the clutch housing 5 fills up again the next time the motor vehicle and thus the hydrodynamic clutch device I are put into operation, this air would prove to be interfering. The blocking element 134 in connection with the sealing seat 136 thus acts as a blocking means 132 for the flow passages 55 in the first flow route 82.

FIG. 3 shows a blocking means 132 in the form of a valve device 140, which is installed in each flow passage 55. The valve device 140 has a valve spring 142, one end of which is supported against a support 144, while the other end is supported on an at least essentially spherical blocking element 134 and which thus generates pretension on the blocking element 134, by means of which this element is pressed against the sealing seat 136. As previously explained on the basis of the blocking element 134 designed as an elastomeric seal 139, the spherical blocking element 134 of the valve device 140 is lifted from its assigned sealing seat 136 when, in the operating state, the pressure in the first supply channel 58 becomes positive versus that in the supply space 44, as a result of which the flow passage 55 of the flow route 82 is unblocked. When the pressure in the first supply channel 82 is no longer positive versus the supply space 44, that is, when the hydrodynamic clutch device is put into the non-operating state, then the blocking element 134 is pushed back into its original position, that is, back onto to the sealing seat 136, under the action of the pretension generated by the valve spring 142. Thus the flow passages 55 are sealed off in an essentially pressure-tight manner. Thus, in this embodiment as well, the blocking element 134, in connection with the sealing seat 136, acts as a blocking means 132 for the flow passages 55 in the first flow route 82.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hydrodynamic clutch arrangement comprising:
a clutch housing which can rotate about an axis of rotation;
a hydrodynamic circuit formed by a pump wheel and a turbine wheel in said clutch housing;
a bridging clutch which can be actuated to establish and release a working connection between a drive and a takeoff;
a pressure space in said clutch housing;
flow routes for connecting the hydrodynamic circuit and the pressure space to at least one pressure medium reservoir, wherein said first flow routes serve to fill the clutch housing with pressure medium for actuating the bridging clutch; and
a blocking arrangement in one of said flow routes, said blocking arrangement opening to unblock said one of said flow routes during an operating state, and closing to block said flow route during a non-operating state.

2. The hydrodynamic clutch arrangement of claim 1 further comprising a hub in the housing, said one of said flow routes comprising a flow passage through said hub, said blocking arrangement comprising a sealing seat in the flow passage and a blocking element which is loaded against the sealing seat until a predetermined pressure is reached in said passage.

3. The hydrodynamic clutch arrangement of claim 2 wherein said blocking element comprises a pre-tensioned ring-shaped element which is fitted around the hub.

4. The hydrodynamic clutch arrangement of claim 3 wherein the pre-tensioned ring-shaped element is an elastomeric seal.

5. The hydrodynamic clutch arrangement of claim 2 wherein the blocking arrangement is a valve device in the flow passage, the valve device comprising a compression spring which loads the blocking element against the sealing seat until said predetermined pressure is reached.

6. The hydrodynamic clutch arrangement of claim 5 wherein the sealing seat narrows the flow passage.

7. The hydrodynamic clutch arrangement of claim 5 wherein the valve device is a throttle-type check valve.

8. The hydrodynamic clutch arrangement of claim 1 wherein the blocking arrangement is in said flow route connected to said hydrodynamic circuit.

9. The hydrodynamic clutch arrangement of claim 1 further comprising a piston for actuating the bridging clutch, the piston separating said pressure space from said hydrodynamic circuit.
